(19) United States
(12) Patent Application Publication
(10) Pub. No.: US 2010/0126133 A1
(43) Pub. Date: May 27, 2010

(54) Coated Particulate Filter And Method

(76) Inventors: Curtis Robert Fekety, Tioga, PA (US); Yunfeng Gu, Painted Post, NY (US); Keith Leonard House, Corning, NY (US); Thomas Dale Ketcham, Big Flats, NY (US); Alper Ozturk, Corning, NY (US); Irene Mona Peterson, Elmira Heights, NY (US); Jianhua Weng, Painted Post, NY (US)

Correspondence Address: CORNING INCORPORATED, SP-TI-3-1, CORNING, NY, 14831, US

(21) Appl. No.: 12/626,100

(22) Filed: Nov. 25, 2009

Related U.S. Application Data
(60) Provisional application No. 61/118,277, filed on Nov. 26, 2008.

(51) Int. Cl. B01D 39/20; B05D 3/02; B05D 7/24; B01D 39/14

(52) U.S. Cl. 55/523; 427/372.2; 427/379; 427/180; 55/524

(57) ABSTRACT

A particulate filter is provided having a filter body with at least one porous wall, and a porous coating on the wall, the coating having a median pore diameter less than 20 microns and a coating pore size deviation of less than 3 times the coating median pore diameter, and the coating having an average thickness of less than 50 microns. A method of manufacturing a particulate filter is also disclosed which includes providing a filter body with at least one porous wall, and depositing particles onto the wall, the particles having a mean particle diameter of less than about 30 microns.

### CROSS REFERENCE To RELATED APPLICATION

This application claims the benefit of priority to U.S. application No. 61/118,277, filed on Nov. 26, 2008.

### FIELD

The disclosure relates generally to particulate filters and methods of making, and more particularly to porous ceramic particulate filters, such as for engine exhaust after-treatment.

### BACKGROUND

Diesel engines and gasoline direct injection (GDI) engines emit particles into the exhaust stream, and removal of the particles from the exhaust stream is desirable.

### SUMMARY

In one aspect, a particulate filter is disclosed herein comprising a filter body comprising at least one porous wall, and a porous coating (or membrane, or layer) on the wall, the coating having a median pore diameter less than 20 microns and a coating pore size deviation of less than 3 times the coating median pore diameter, and the coating having an average thickness of less than 50 microns.

In another aspect, a method of manufacturing a particulate filter is disclosed herein comprising providing a filter body comprising at least one porous wall, and depositing particles onto the wall, the particles having a mean particle diameter of less than about 30 microns.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1A shows calculated filtering efficiency for soot particles (typical of the size created by a GDI auto engine) as a function of pore size and coating thickness.

FIG. 1B shows calculated filter back pressure as a function of pore size and coating thickness.

FIG. 2 shows a very narrow size distribution ceramic powder on a glass slide in a single thickness. A spherical ceramic powder of about 5 microns in diameter, single layer, is shown.

FIG. 3 shows a schematic of a coating layer of narrow size distribution ceramic powder on a porous substrate honeycomb wall, with fugitive particles in the wall.

FIG. 4a shows a schematic of a coating layer of narrow size distribution ceramic powder with similar sized fugitive particles on a porous substrate honeycomb wall, with larger fugitive particles in the wall.

FIG. 4b shows a schematic of a coating layer of narrow size distribution ceramic powder with similar diameter porosity particles on a porous substrate honeycomb wall, after fugitive particle removal.

FIG. 5a is a photograph of a narrow size distribution ceramic powder made by an aerosol technique.

FIG. 5b is a graphic illustration of measured narrow size distribution of the powder of FIG. 5a.

FIG. 5c is a graphic illustration of measured mass distribution of the narrow size distribution powder of FIG. 5a.

FIG. 6 shows SEM images of surface morphology of (a) low-microcracked cordierite bare support; (b) AA3 alumina coating on low-microcracked cordierite support; and (c) C701 alumina coating on low-microcracked cordierite support.

FIG. 7 shows SEM images of surface morphology of membrane alumina coatings and bare support as well: (a) low-microcracked cordierite bare support; (b) AA3 alumina coating on low-microcracked cordierite support; and (c) C701 alumina coating on low-microcracked cordierite support.

FIG. 8 shows the pore size distribution of stand-alone AA-3 and C701 alumina membranes fired at 1380 C for 2 hours, as obtained by Hg porosimetry, wherein AA-3 membrane had a narrower pore size distribution.

FIG. 9 shows SEM images of alumina membrane layers coated on low-microcracked cordierite supports with different pretreatment drying profiles: #1 sample: room temperature for 23 hours; #2 sample: 60 C for 23 hours; #3 sample: room temperature for 5 hours and then 60 C for 18 hours.

### DETAILED DESCRIPTION

Reference will now be made in detail to embodiment(s) of the invention, examples of which are illustrated in the accompanying drawings. Whenever possible, the same reference numerals will be used throughout the drawings to refer to the same or like parts.

In accordance with the invention, the present disclosure provides particulate filters and methods of making the particulate filters.

In one aspect, the particulate filter comprises a filter body comprising at least one porous wall, and a porous coating on the wall, the coating having a median pore diameter less than 20 microns and a coating pore size deviation of less than 3 times the coating median pore diameter, and the coating having an average thickness of less than 50 microns.

In some of these embodiments, the median pore diameter of the coating is less than or equal to 15 microns. In some of these embodiments, the median pore diameter of the coating is less than or equal to 10 microns. In some of these embodiments, the median pore diameter of the coating is less than or equal to 5 microns. In some of these embodiments, the median pore diameter of the coating is less than or equal to 2 microns. In some of these embodiments, the median pore diameter of the coating is less than or equal to 1 micron. In some embodiments, the median pore diameter of the coating is between about 0.3 microns and about 10.0 microns. In some embodiments, the median pore diameter of the coating is between about 0.3 microns and about 3.0 microns. In some embodiments, the median pore diameter of the coating is between about 0.5 microns and about 3.0 microns. In some embodiments, the median pore diameter of the coating is between about 0.5 microns and about 2.5 microns. In some embodiments, the median pore diameter of the coating is between about 1.0 microns and about 2.0 microns.

In some embodiments, the pore size deviation of the coating is less than 2 times the median pore diameter of the coating.

In some embodiments, the median pore diameter of the coating is between about 0.3 microns and about 10.0 microns, and the pore size deviation of the coating is less than 2 times the median pore diameter of the coating.

In some embodiments, the median pore diameter of the coating is about one order of magnitude smaller than a median pore diameter of the wall.

In some embodiments, a median pore diameter of the wall is about one order of magnitude larger than the median pore diameter of the coating.

In some embodiments, the wall has a median pore diameter of greater than about 5 microns. In some of these embodiments, the wall has a median pore diameter of greater than about 10 microns. In some of these embodiments, the wall has a median pore diameter of greater than about 20 microns. In some of these embodiments, the wall has a median pore diameter of greater than about 50 microns. In some of these embodiments, the wall has a median pore diameter of greater than about 100 microns.

In some embodiments, the coating has an average thickness of less than 25 microns. In some of these embodiments, the coating has an average thickness of less than 15 microns. In some embodiments, the coating has an average thickness of greater than about 3 microns and less than about 30 microns. In some embodiments, the coating has an average thickness of greater than about 5 microns and less than about 25 microns.

In some embodiments, the coating has an average thickness of greater than about 3 microns and less than about 15 microns, and the median pore diameter of the coating is between about 0.3 microns and about 5.0 microns.

In some embodiments, the coating has an average thickness of greater than about 3 microns and less than about 15 microns, and the median pore diameter of the coating is between about 0.5 microns and about 3.0 microns.

In some embodiments, the coating has an average thickness of greater than about 3 microns and less than about 15 microns, and the median pore diameter of the coating is between about 0.5 microns and about 2.5 microns.

In some embodiments, the coating has a total porosity of greater than 40%. In some of these embodiments, the coating has a total porosity of greater than about 45%. In some of these embodiments, the coating has a total porosity of greater than about 50%. In some of these embodiments, the coating has a total porosity of greater than about 55%. In some of these embodiments, the coating has a total porosity of less than about 65%. In some embodiments, the coating has a total porosity of between about 50% and about 60%.

In some embodiments, the coating is comprised of a ceramic. In some embodiments, the coating comprises at least one compound of a group consisting of alumina, cordierite, aluminosilicate, aluminum titanate, zirconia, alumina-zirconia, La-alumina, silicon carbide, ceria, zeolite, and combinations thereof.

In some embodiments, the coating comprises a catalyst. The catalyst may comprise a precious group metal. In some embodiments, the catalyst comprises W, V, Pt, Rh, or Pd, or combinations thereof.

In some embodiments, the catalyst promotes (a) the oxidation of carbon monoxide, (b) the oxidation of hydrocarbons, (c) the reduction of nitrogen oxides, or (d) oxidation of carbon soot, or combinations of (a), (b), (c) or (d).

In some embodiments, the coating comprises a NOx absorber.

In some embodiments, the porous wall is comprised of a ceramic. The porous wall may be comprised of alumina, cordierite, aluminosilicate, aluminum titanate, zirconia, alumina-zirconia, La-alumina, silicon carbide, ceria, zeolite, silicon nitride, or combinations thereof.

In some embodiments, the coating comprises a compound not found within the wall.

In some embodiments, the filter body comprises a plurality of porous walls, or a matrix of porous walls. The matrix can comprise intersecting porous walls. The matrix can define a plurality of parallel channels, such as in the form of a honeycomb structure. The honeycomb structure can define a plurality of quadrilateral channels, or a plurality of hexagonal channels, or channels of other cross-sectional shape.

In some embodiments, at least part of the coating is present within the pores of the porous wall.

In some embodiments, at least part of the coating is present on a peripheral surface of the porous wall and not within the pores of the porous wall.

In another aspect of the present disclosure, a method of manufacturing a particulate filter is provided comprising providing a filter body comprising at least one porous wall, and depositing particles onto the wall, the particles having a mean particle diameter of less than about 30 microns. Preferably, the deposited particles are heated. Preferably, the particles are deposited onto the wall sufficient to form a coating on at least a portion of the wall, and then the coating is heated

In some embodiments, the particles having a mean particle diameter of less than about 20 microns. In some of these embodiments, the particles have a mean particle diameter of less than about 15 microns. In some of these embodiments, the particles have a mean particle diameter of less than about 10 microns. In some of these embodiments, the particles have a mean particle diameter of less than about 5 microns.

In some embodiments, the particles are substantially monodisperse. In some embodiments, the filter body is comprised of one or more oxides. In some embodiments, the filter body is comprised of one or more non-oxides. In some embodiments, the filter body is comprised of a ceramic material.

In some embodiments, the particles comprise non-fugitive particles and fugitive particles. In some embodiments, the particles comprise non-fugitive material and fugitive material. If fugitive material or fugitive particles are utilized, the method further comprises heating the coating sufficient to remove at least some of the fugitive material from the wall, i.e. from on the porous wall and/or from within the wall.

In some embodiments, the particles are carried by a carrier fluid stream toward the porous wall, and the carrier fluid stream passes through the wall, and the wall separates the particles from the carrier fluid stream.

In some embodiments, the particles have a mean particle diameter of less than about 10 microns.

In some embodiments, the particles are deposited in aerosol form; the particles can be deposited in the form of sol/gel spheres; in some of these embodiments, the particles pass through a heated gas environment prior to being deposited onto the filter body. As generated in aerosol form, the particles can have a median particle diameter of less than 100 microns, or even less than 50 microns. In some embodiments, when the particles are deposited in aerosol form, the aerosol particles are converted to ceramic particles in situ near or at the wall.

In some embodiments, the particles comprise non-fugitive particles comprised of non-fugitive material and fugitive particles comprised of fugitive material, wherein the fugitive particles are carried by a first carrier fluid stream and the first carrier fluid stream passes through the wall, wherein the wall separates the fugitive particles from the first carrier fluid stream, and wherein the non-fugitive particles are carried by a second carrier fluid stream and the second carrier fluid stream passes through the wall, wherein the wall separates the non-fugitive particles from the second carrier fluid stream, thereby forming a coating comprised of the fugitive material and the non-fugitive material. Subsequently, the coating is preferably heated sufficient to remove at least some of the fugitive material from the coating. In some embodiments, the fugitive particles are deposited onto the wall prior to the non-fugitive particles being deposited onto the wall. In some embodiments, the median particle diameter of the fugitive particles is greater than the mean particle size of the non-fugitive particles; in some embodiments, the median particle diameter of the fugitive particles is at least 25% greater than the mean particle size of the non-fugitive particles; in some embodiments, the median particle diameter of the fugitive particles is at least 100% greater than the mean particle size of the non-fugitive particles; in some embodiments, the median particle diameter of the fugitive particles is at least 300% greater than the mean particle size of the non-fugitive particles; in some embodiments, at least some of the fugitive particles are at least 400% larger than the median particle diameter of the non-fugitive particles.

Preferably, the non-fugitive particles are comprised of an inorganic material.

The method may further comprise, prior to depositing the particles, plugging at least some pores in at least a portion of the wall with a pore filler to form a plugged region.

In some embodiments, the pore filler is comprised of an organic material; in some of these embodiments, the pore filler is comprised of a polymer; in some of these embodiments, the pore filler is comprised of a protein agglomerate, or a protein polymer, such as derived from a milk; in other embodiments, the polymer is a starch or a synthetic polymer.

In some embodiments, the plugging comprises wetting the wall with a pore plugging mixture (which may include a solution, or suspension, or colloid) comprising the pore filler, and the method further comprises then drying the wall sufficient to form the plugged region. In some embodiments, the filter body is immersed in the pore plugging mixture during the wetting.

In some embodiments, after the wetting, the filter body, including the wall, is dried in a drying environment at about room temperature for at least 5 hours, and in some of these embodiments at least 10 hours, and in other of these embodiments at least 20 hours.

In some embodiments, after the wetting, the filter body is dried in a drying environment between 15° C. and 30° C. for at least 5 hours, and in some of these embodiments at least 10 hours, and in other of these embodiments at least 20 hours.

In some embodiments, after the wetting, the filter body is dried in a drying environment at about 20° C. for at least 5 hours, and in some of these embodiments at least 10 hours, and in other of these embodiments at least 20 hours

In some embodiments, after the wetting, the filter body is dried in a drying environment at one or more temperatures greater than about 20° C. and less than 120° C. for greater than or equal to 5 hours and less than or equal to 20 hours.

In some embodiments, after the wetting, the filter body is dried in a drying environment at one or more temperatures between 15° C. and 30° C. for between 4 and 15 hours, and then in an atmosphere at one or more temperatures between 15° C. and 120° C. for greater than or equal to 5 hours and less than or equal to 20 hours.

In some embodiments, the filter body is wetted via dip-coating with the pore plugging mixture, or flow-coating with the pore plugging mixture, or both.

In some embodiments, the filter body is cleaned prior to the wetting with the pore plugging mixture. The filter body can be flushed with a fluid prior to the wetting with the pore plugging mixture, and/or the filter body can be flushed with a forced gas prior to the wetting with the pore plugging mixture. In some embodiments, the filter body is flushed with deionized water then dried prior to the wetting with the pore plugging mixture. In some embodiments, the filter body is dried in a drying environment at a temperature greater than 100° C. for greater than 5 hours prior to the wetting with the pore plugging mixture. In some embodiments, the filter body is dried in a drying environment at a temperature greater than 100° C. for between 5 and 24 hours prior to the wetting with the pore plugging mixture. In some embodiments, the filter body is dried in a drying environment at about 120° C. for between 5 and 24 hours prior to the wetting with the pore plugging mixture.

In some embodiments, the depositing of the particles comprises contacting the wall with a liquid-based coating mixture containing the particles. In some embodiments, the coating mixture is water-based. In some embodiments, the coating mixture comprises at least one of the group consisting of deionized water, alpha-alumina particles, cordierite particles, a dispersant, a binder, an anti-foam agent, a pore former, and combinations thereof In some embodiments, the particles comprise at least one of the group consisting of alpha-alumina particles, cordierite particles, and combinations thereof.

In some embodiments, after the particles are deposited, the filter body is dried. In some embodiments, after the particles are deposited, the filter body is dried, and then the filter body is fired. In some embodiments, the drying environment is kept at a humidity greater than 50%, and in some embodiments between 50 and 75% humidity. Firing can include burnout of the fugitive material (such as protein), for example at furnace temperatures of 600-700 C, and at controlled oxygen levels.

In some embodiments, the filter body is dried in a drying environment at a temperature greater than 100° C. for greater than 2 hours. In some embodiments, the filter body is dried in a drying environment at a temperature between 100° C. and 150° C. for between 2 hours and 8 hours.

In some embodiments, the filter body is fired in a firing environment at a temperature greater than 1150° C. for greater than 0.5 hours. In some embodiments, the filter body is fired in a firing environment at a temperature between 1150° C. and 1380° C. In some embodiments, the filter body is fired in a firing environment at a temperature between 1150° C. and 1380° C. for 0.5 to 5 hours. In some embodiments, the filter body is fired in a firing environment at a temperature between 1150° C. and 1380° C. for 0.5 to 5 hours at a heating rate of 0.5 to 2° C./min In some embodiments, the filter body is fired in a firing environment at a temperature in a range between 1150° C. and 1380° C. for 0.5 to 5 hours, and the temperature does not change in the range by more than 2° C./min

In some embodiments, the particles form a coating on the plugged region, and the method further comprises heating the coating for a time and at a temperature sufficient to remove at least some of the pore filler.

Coatings with narrow size distribution porosity on porous ceramic filters can be thinner, while still capturing a similar amount of particles. Using narrow size distribution ceramic powder for the coatings or for the fugitive “pore former” part of the coating help to make such narrow pore size distribution coatings. Aerosol and fluid precipitation methods can make narrow size distribution/mono-dispersed powders. This thin, narrow sized distribution porosity coating from narrow size distribution powder leads to lower back pressure and better fuel efficiency for the engine utilizing an exhaust system with the filter disclosed herein.

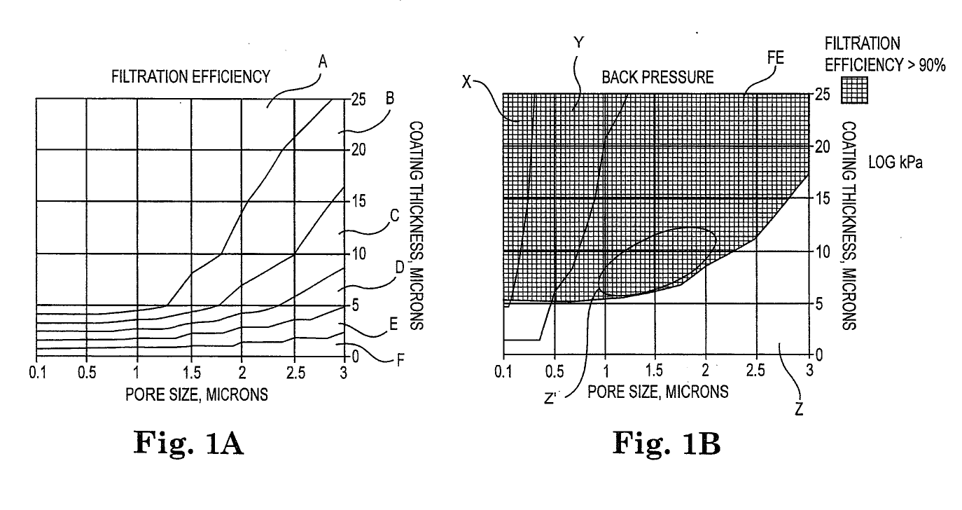

The calculated filtration efficiency of an exemplary 400/6 (400 cells per square inch, 6 mil (0.006 inch) wall thickness) substrate with 60% porosity as a function of membrane coating thickness and coating pore size are shown in FIG. 1A. FIG. 1A shows calculated filtering efficiency for soot particles (typical of the size created by a GDI auto engine) as a function of pore size and coating thickness (A: 95-100% Filtration efficiency; B: 90-95%; C: 85-90%; D: 80-85%; E: 75-80%; F: 70-75%). FIG. 1B shows, calculated filter back pressure as a function of pore size and coating thickness (X: 2-3 Log kPa backpressure; Y: 1-2 Log kPa backpressure; Z: 0-1 Log kPa backpressure) with the shaded overlay portions FE corresponding to Filtration Efficiency >90%). The region Z in FIG. 1B shows the calculated combination of membrane thickness and porosity which allows both good filtration efficiency and low backpressure, such as would be suitable for at least one embodiment as a gasoline particulate filter (GPF) such as in a gasoline direct injection engine exhaust system.

U.S. Pat. No. 4,871,489 assigned to Corning Incorporated, incorporated by reference herein, describes a method to make very narrow size distribution ceramic powders. Very narrow size distribution powders, powders with particular distributions from particular aerosol methods or mixes of controlled sized distribution powders, some which could be fugitive, can give the desired coating thicknesses and narrow size distribution porosity.

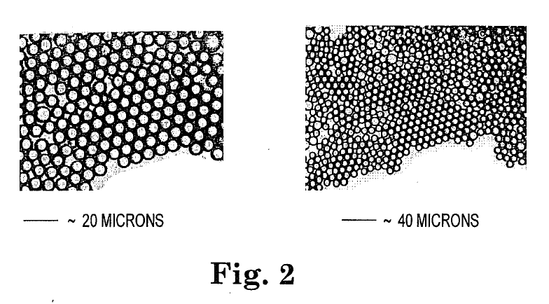

FIG. 2 shows a very narrow size distribution ceramic powder on a glass slide in a single thickness. A spherical ceramic powder of about 5 microns in diameter, single layer, is shown.

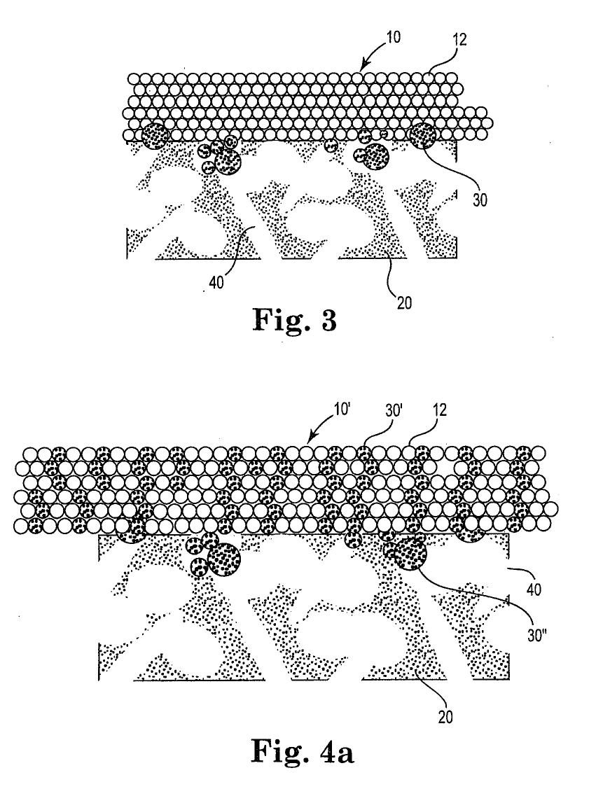

FIG. 3 shows a schematic of a coating layer 10 of narrow size distribution ceramic powder on a porous substrate honeycomb wall 20, with fugitive particles 30 in the wall. Fugitive particles 30 can plug the pores 40 in the honeycomb 20 to prevent filling of the honeycomb pores 40 with the smaller coating particles 12.

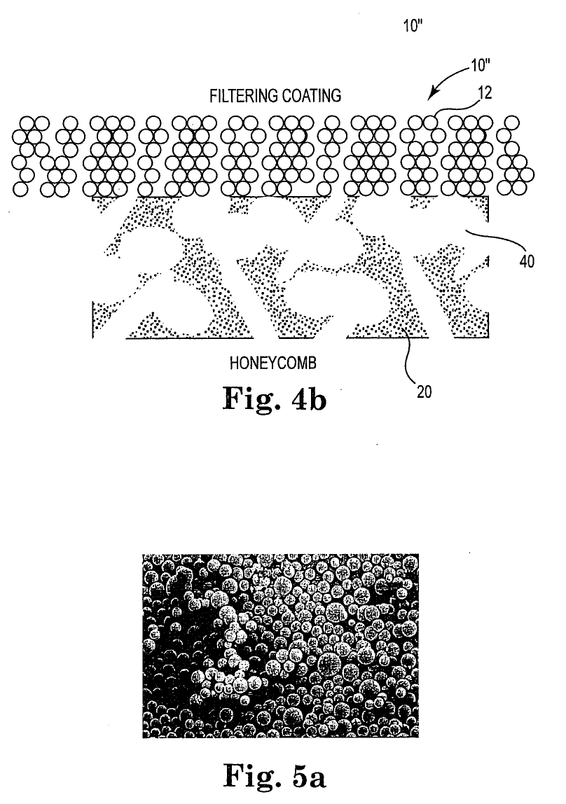

FIG. 4a shows a schematic of a coating layer 10′ of narrow size distribution ceramic powder with similar sized fugitive particles 30′ on a porous substrate honeycomb wall 20 (i.e. the particle sizes of the ceramic powder are similar in size to the fugitive particles 30′ lodged inside the porous substrate ceramic honeycomb wall.), with larger fugitive particles 30″ in the wall. Fugitive particles can plug the pores 40 in the honeycomb to prevent filling of the honeycomb pores with the smaller coating particles and can be part of the coating particles to form coatings with more porosity and pores with larger pore diameter.

FIG. 4b shows a schematic of a coating layer 10″ of narrow size distribution ceramic powder with similar diameter porosity particles 12 on a porous substrate honeycomb wall 20, after fugitive particle removal. Fugitive particles e.g. 30, 30′, 30″ have been removed leaving the pores in the honeycomb unfilled and a coating with more porosity and pores 40 with larger pore diameter, for example as compared to FIG. 3.

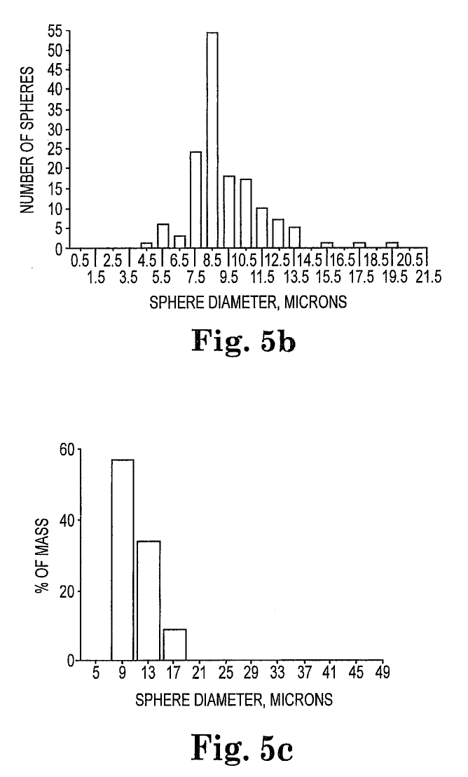

FIG. 5a is a photograph of a narrow size distribution ceramic powder made by an aerosol technique described in U.S. Pat. No. 4,871,489.

FIG. 5b is a graphic illustration of measured narrow size distribution of the powder of FIG. 5a.

FIG. 5c is a graphic illustration of measured mass distribution of the narrow size distribution powder of FIG. 5a.

Narrow size distribution powders can be made by several methods, aerosol methods such as mentioned above, FIGS. 2 and 5, fluid precipitation and growth methods similar to a continuous “Stober silica” process, as well as simple size classification of average powder. With some methods, particularly aerosol methods where the aerosol particles are converted to ceramic particle in situ, the powder can be deposited as coating onto the honeycomb as they are created, {i.e. sol/gel spheres (in the approximately tens of microns and under size range) flow as an aerosol through a furnace}. The carrier gas flows through the honeycomb filter and the coating forms as the aerosol particles are filtered out of the carrier gas. Preferably the coating particles do not clog the pores of the honeycomb. Using a second gas stream, a fugitive set of particles of a larger size can be put into the pores of the honeycomb prior to the coating layer to prevent the clogging of the honeycomb pores with the coating particles, FIG. 3.

To increase the porosity while keeping the pore size small, fugitive particles of similar size can be put in the ceramic power coating. Ceramic powders can be made highly porous, and they can also serve as catalyst carriers. Alumina, zirconia, alumina-zirconia, La-alumina have been demonstrated as aerosol powders with narrow size distribution. Ceria can be made as well. NOx absorbers, zeolites, other materials can be made as narrow size distribution ceramic powders. These compositions can be utilized to provide a catalytic, oxygen storage, NOx capture, or hydrocarbon capture function in addition to the filtration function.

### EXAMPLES

In one set of embodiments of the present disclosure, a method is provided to make a thin filtration layer on a honeycomb support, including a honeycomb support with polygonal or hexagonal or quadrilateral or square channels. The method comprises plugging pores of the support with pore-filler such as skim milk, deposition of one inorganic filtration layer on the pretreated surface, and firing to remove the pore-filler. We have found that the resulting filtration layer can attain a pore diameter of about one order smaller than the pore diameter of the support. This method allows direct deposition of inorganic membranes of small pores on a support of large pores, which can reduce cost as compared to conventional multiple layer coating steps, and can also improve filtration efficiency while minimize backpressure penalty due to small pore diameter and reduction of coating thickness. The method in these embodiments comprises pretreatment of a honeycomb support, and then slip-casting. The pretreatment process includes the following steps. First, the honeycomb supports are flushed with deionized water or blown with forced air to remove any loose particles or debris. The washed samples are dried at a 120 C oven for 5-24 hours. Second, the pore-filling material is sucked into pores of the ceramic support by either dip-coating or other methods such as the flow-coating technique. Only the inner channel surfaces of the support contact the pore-filling solution. After the support is immersed in the solution for a period of time, the support is taken out of the solution. The modified support is dried at room temperature for 23 hours, or at a higher temperature but less than 120 C for 5-20 hours, or at room temperature for 5-6 hours and then at a higher temperature but less than 120 C for 5-20 hours. The supports are ready for coating of an inorganic membrane layer by the slip-casting process.

The slip-casting process includes slip preparation, coating, drying and firing. The water-based slip contains deionized water, alpha-alumina particles or cordierite particles, dispersant, binder and anti-foam agent. The pore former can be used to increase porosity. The coating is conducted on the pretreated support using a dip-coating method. The coated supports are first dried at 120 C for 5 hours and then fired at 1150-1380 C for 0.5-5 hours at a heating rate of 0.5-2 C/min according to sintering temperature requirements for different materials.

### Example 1

### Filtration Membrane Layer Coated on Cordierite Honeycomb Support

This example illustrates coating of alumina filtration layer on a porous cordierite honeycomb support without pretreatment of the support before coating. A 400/6 low-microcracked cordierite honeycomb support with square channels uniformly distributed over the cross-sectional area had a cell density of 400 cells/in² and wall thickness of 6 mil (150 μm), leading to a GSA of ˜2750 m²/m³. Median pore diameter d50 was 9.89 μm and d95 was 44.43 μm with total porosity of 60.8%, as measured by mercury porosimetry. The support was flushed through the channels with deionized water. The support was fully dried at 120° C. oven overnight. Two alumina slips with a solid concentration of 40 wt. % were prepared using alumina materials of different particle sizes (AA-3 and C701). The alumina AA-3 (Sumitomo Chemical Co.) has a narrow particle size distribution with a median particle size of 2.7-3.6 μm, while the alumina C701 has a broad size distribution with a median particle size of 6.3 μm. First, 0.20 g of Tiron (4,5-Dihydrony-1,3-benzenedissulfonic acid disodium salt, Fluka) was added into a 150 ml plastic jar with 123 g D.I. water, to which 100 g alumina powder was then added. Upon shaking for around 1 min, the jar was put into an ice bath and ultrasonicated for 30 times with 10 sec ON and 30 sec OFF intervals. Next, the treated slip was mixed with 31.3 g 20 wt % PEG (polyethylene glycol, MW=20,000, Fluka) and 2.30 g 1% DC-B anti-foam emulsion solution (Dow-Corning). After ball-milling for 15-20 h, the slip was poured through a fine screen into a flask, followed by degassing with a vacuum pump. The alumina coatings were placed inside the channels of the support using a dip-coating method. The soaking time was 10 sec. After coating, the excess alumina slip in the channels was removed. After being dried at 120° C. for 2 hours, the coated sample was fired at 1380° C. for 2 hours at a heating rate of 1° C./min.

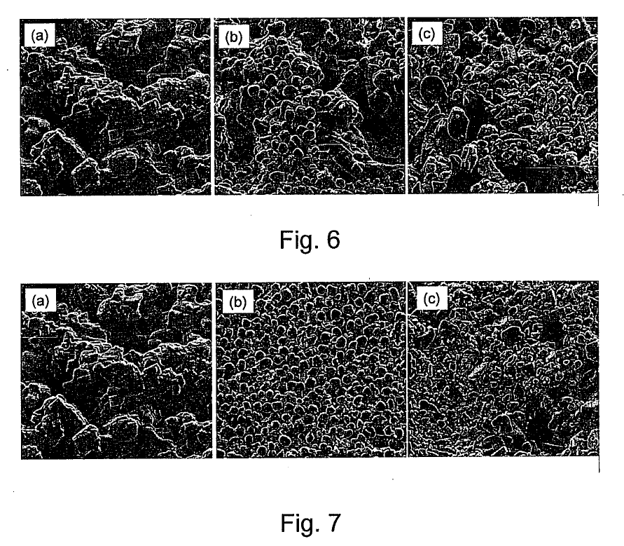

The SEM images of uncoated support and two coated supports were shown in FIG. 6. FIG. 6(a) shows that some pores of the support were as large as 30 μm, although the median pore size was 10 μm (Hg porosimetry). FIG. 6(b) shows no formation of continuous membranes on the support when the alumina AA-3 of median particle size of ˜3 μm was used, due to the fact that the small alumina particles penetrated into pores of the support. FIG. 6(c) indicates that a continuous membrane was not formed when the large alumina particle C701 of 6 μm with broad particle size distribution was used.

### Example 2

### Filtration Membrane Layer Coated on Cordierite Honeycomb Support

This example illustrates coating of two alumina membranes on a porous cordierite honeycomb support modified with skim milk. The same low-microcracked cordierite support was used as in Example 1. The coating process was also the same except for addition of a pretreatment process before the slip-casting.

The flushed and dried monolith support was wrapped with Teflon tape and dipped into the Great Value™ skim milk. After soaking for 10 seconds, the excess milk was drained out and dried at ambient condition for 5-6 hours and subsequently at 60 C for 15 hours. The support was kept wrapped during the whole drying process. Then, the pretreated support was coated with the 40 wt. % alumina slip AA-3—same as in Example 1. After drying at 120° C. and firing at 1380° C. As another example, the same pretreated support was coated with 40 wt. % alumina slip C701 and then dried and fired at 1380° C. The resulting alumina membranes were characterized by SEM. A smooth and uniform membrane was formed as shown in FIG. 7(a) and (b). The side membrane thickness was around 10 μm while the corner membrane was thicker.

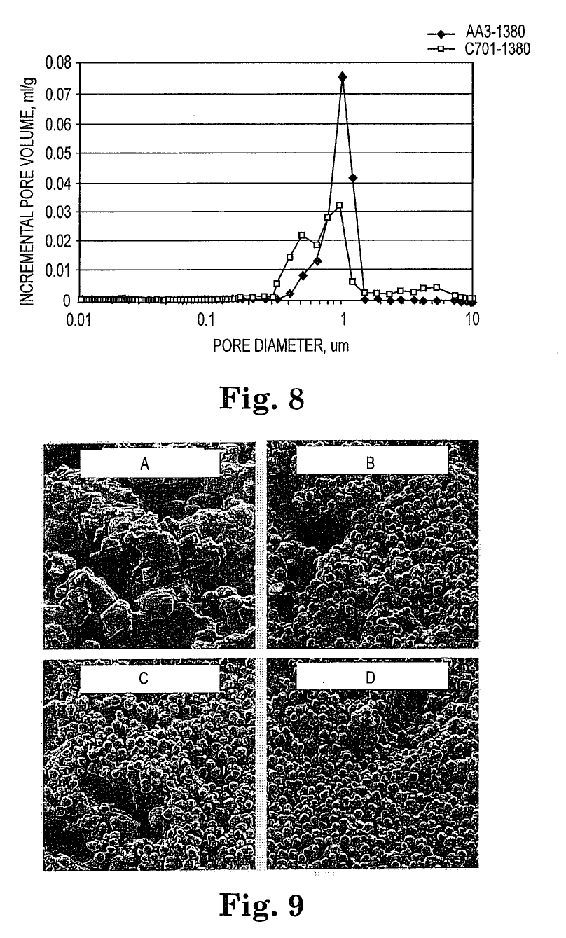

FIG. 8 shows the pore size distribution of stand-alone AA-3 and C701 membranes. These two membranes had the same median pore size of 1.1 μm and porosity of 47%, while AA-3 had a narrow pore size distribution due to narrow particle size distribution as shown in FIG. 7

### Example 3

### Alumina Membrane Layers Coated on Low-microcracked Support

This example illustrates alumina filtration membranes coated on low-microcracked cordierite support but with different pretreatment drying profiles.

After the low-microcracked supports were soaked and then taken out of the Great Value™ skim milk, #1 support was dried at room temperature (˜20° C.) for 23 hours, and #2 support was dried at 60° C. for 23 hours, and #3 support was first dried at room temperature for 5 hours and subsequently dried at 60° C. for 18 hours. All supports kept wrapped during the drying process. Three dried supports were then coated with the same 40 wt. % alumina AA-3 slip, followed by drying and firing at 1380° C. for 2 hours.

FIG. 9 shows SEM images of surface morphology of resulting alumina membrane coatings. The alumina membrane coated on #3 support with combined drying profile show more uniform surface morphology. As seen from this example, the structure of the final alumina membrane coating can be affected by the drying profile used for the pretreatment of the bare support.

### Example 4

### Cordierite Membrane Layer Coated on Low-microcracked Support

This example illustrates a cordierite filtration membrane coated on a low-microcracked support.

One cordierite slip with a solid concentration of 40 wt. % was prepared in this example. First, 0.10 g of Tiron (4,5-Dihydrony-1,3-benzenedissulfonic acid disodium salt, Fluka) was added into a 150 ml plastic jar with 61.3 g D.I. water, to which 50 g alumina powder was then added. Upon shaking for around 1 min, the jar was put into an ice bath and ultrasonicated for 30 times with 10 sec ON and 30 sec OFF intervals. Next, the treated slip was mixed with 15.6 g 20 wt% PEG (polyethylene glycol, MW=20,000, Fluka) and 1.4 g 1% DC-B anti-foam emulsion solution (Dow-Corning). After ball-milling for 15-20 h, the slip was poured through a fine screen into a flask, followed by degassing with a vacuum pump.

The cordierite membrane layer was coated on the low-microcracked support with use of the same procedure as for alumina membrane layers, which comprised pretreatment of the support with skim milk, dip-coating of the pretreated support with the cordierite slip, and drying and firing.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A particulate filter comprising:
a filter body comprising at least one porous wall;
a porous coating on the wall, the coating having a median pore diameter less than 20 microns and a coating pore size deviation of less than 3 times the coating median pore diameter, and the coating having an average thickness of less than 50 microns.

2. The particulate of claim 1 wherein the median pore diameter of the coating is less than or equal to 5 microns.

3. The particulate of claim 1 wherein the median pore diameter of the coating is between about 0.3 microns and about 3.0 microns.

4. The particulate of claim 1 wherein the pore size deviation of the coating is less than 2 times the median pore diameter of the coating.

5. The particulate of claim 1 wherein the median pore diameter of the coating is about one order of magnitude smaller than a median pore diameter of the wall.

6. The particulate of claim 1 wherein the wall has a median pore diameter of greater than about 5 microns.

7. The particulate of claim 1 wherein the coating has an average thickness of less than 25 microns.

8. The particulate of claim 1 wherein the coating has a total porosity of greater than 40%.

9. The particulate of claim 1 wherein the coating is comprised of a ceramic.

10. The particulate of claim 1 wherein the porous wall is comprised of a ceramic.

11. The particulate of claim 1 wherein the coating comprises a compound not found within the wall.

12. A method of manufacturing a particulate filter comprising:
providing a filter body comprising at least one porous wall;
depositing particles onto the wall, the particles having a mean particle diameter of less than about 30 microns.

13. The method of claim 12 wherein the particles are substantially monodisperse.

14. The method of claim 12 wherein the filter body is comprised of one or more oxides.

15. The method of claim 12 wherein the particles are deposited onto the wall sufficient to form a coating on at least a portion of the wall.

16. The method of claim 15 further comprising heating the coating.

17. The method of claim 12 wherein the particles comprise non-fugitive material and fugitive material.

18. The method of claim 12 wherein the particles are deposited in aerosol form.

19. The method of claim 12 wherein the particles comprise non-fugitive particles comprised of non-fugitive material and fugitive particles comprised of fugitive material, wherein the fugitive particles are carried by a first carrier fluid stream and the first carrier fluid stream passes through the wall, wherein the wall separates the fugitive particles from the first carrier fluid stream, and wherein the non-fugitive particles are carried by a second carrier fluid stream and the second carrier fluid stream passes through the wall, wherein the wall separates the non-fugitive particles from the second carrier fluid stream, thereby forming a coating comprised of the fugitive material and the non-fugitive material.

20. The method of claim 12 further comprising, prior to depositing the particles, plugging at least some pores in at least a portion of the wall with a pore filler to form a plugged region.

21. The method of claim 20 wherein the pore filler is comprised of one or more the group consisting of: an organic material, a polymer, a protein agglomerate, a protein polymer, a protein polymer is derived from a milk, a starch, synthetic polymer, and combinations thereof

22. The method of claim 12 wherein the depositing of the particles comprises contacting the wall with a liquid-based coating mixture containing the particles.

23. The method of claim 12 wherein, after the particles are deposited, the filter body is dried, and then the filter body is fired.
